(19) United States
(12) Patent Application Publication
(10) Pub. No.: US 2025/0260142 A1
(43) Pub. Date: Aug. 14, 2025

(54) BATTERY

(71) Applicant: TOYOTA JIDOSHA KABUSHIKI KAISHA, Toyota-shi (JP)

(72) Inventors: Tsuyoshi EHARA, Toyota-shi (JP); Shigenori Hama, Okazaki-shi (JP); Hiroshi Nagase, Nagoya-shi (JP)

(73) Assignee: TOYOTA JIDOSHA KABUSHIKI KAISHA, Toyota-shi (JP)

(21) Appl. No.: 19/043,893

(22) Filed: Feb. 3, 2025

(30) Foreign Application Priority Data
Feb. 9, 2024 (JP) 2024-018651

(51) Int. Cl. H01M 50/557; H01M 10/0585; H01M 50/103; H01M 50/533; H01M 50/54

(52) U.S. Cl. CPC H01M 50/557; H01M 10/0585; H01M 50/103; H01M 50/533; H01M 50/54

(57) ABSTRACT

Disclosed is a battery capable of improving connectivity between a terminal and a current collector part while improving structural efficiency around the terminal and the current collector part. The battery of the present disclosure includes an electrode laminate, a current collector part, and a terminal. The current collector part protrudes from the electrode laminate. The terminal has a contact surface with the current collector part. The contact surface has a curved surface. The curved surface bulges toward a side opposite the current collector part.

### FIELD

The present disclosure relates to a battery.

### BACKGROUND

Patent Literature 1 discloses a battery, wherein an electrode laminate and a lid terminal are electrically connected via a current collector part, an exterior body is adhered to an outer periphery of the lid terminal, and the current collector part and the electrode laminate are housed inside the exterior body.

### CITATION LIST

### Patent Literature

[PTL 1] Japanese Unexamined Patent Publication No. 2023-084066

### SUMMARY

### Technical Problem

Conventional batteries have room for improvement in terms of improving structural efficiency around the terminal and the current collector part, and improving connectivity between the terminal and current collector part.

### Solution to Problem

The present disclosure provides, as means for achieving the object described above, the following multiple aspects.

### <Aspect 1>

A battery, comprising an electrode laminate, a current collector part, and a terminal, wherein
the current collector part protrudes from the electrode laminate,
the terminal has a contact surface with the current collector part,
the contact surface has a curved surface, and
the curved surface bulges toward a side opposite the current collector part.

### <Aspect 2>

The battery according to Aspect 1, wherein
the electrode laminate and the current collector part are housed in an exterior body,
the terminal has the contact surface on an interior of the exterior body, and
the terminal has an exposed surface facing an outside of the exterior body.

### <Aspect 3>

The battery according to Aspect 1 or 2, wherein
the terminal comprises a base and a protrusion,
the base has a first surface and a second surface opposite the first surface,
the protrusion protrudes from the base toward the electrode laminate,
the protrusion comprises a first protrusion and a second protrusion,
the first protrusion has a third surface facing the second protrusion and a fourth surface opposite the third surface,
the second protrusion has a fifth surface facing the first protrusion and a sixth surface opposite the fifth surface, and
at least one of the first surface, the third surface, and the fifth surface has the contact surface.

### <Aspect 4>

The battery according to Aspect 3, wherein
the electrode laminate and the current collector part are housed in an exterior body,
the first surface, the third surface, and the fifth surface face an interior of the exterior body,
the second surface faces an exterior of the exterior body, and
the fourth surface and the sixth surface are adhered to the exterior body.

### <Aspect 5>

The battery according to any one of Aspect 3 or 4, wherein
a planar shape of the base is a rectangle,
the protrusion comprises a third protrusion and a fourth protrusion,
the rectangle comprises a first side and a second side facing each other and a third side and a fourth side facing each other,
the first protrusion protrudes from the first side,
the second protrusion protrudes from the second side,
the third protrusion protrudes from the third side, and
the fourth protrusion protrudes from the fourth side.

### Effects

According to the battery of the present disclosure, structural efficiency around the terminal and the current collector part can easily be improved (space can easily be saved), and connectivity between the terminal and the current collector part can easily be improved.

### BRIEF DESCRIPTION OF DRAWINGS

FIG. 1 schematically shows an example of the external configuration of a battery.

FIG. 2 schematically shows an example of the configuration of the cross section taken along line II-II of FIG. 1.

FIG. 3 schematically shows an example of the configuration of the cross section taken along line III-III of FIG. 1.

FIG. 4 schematically shows an example of the configuration of the cross section taken along line IV-IV of FIG. 1.

FIG. 5 schematically shows an example of the external shape of a terminal.

FIG. 6 schematically shows an example of the cross section of a terminal.

FIG. 7 schematically shows an example of the cross section of a terminal.

FIG. 8 schematically shows an example of the cross section of a terminal.

FIG. 9 schematically shows an example of the cross section of a terminal.

FIG. 10 schematically shows an example of an adherence state between a terminal and an exterior body. The current collector part and electrode laminate are omitted.

FIG. 11 is a view detailing problems of a battery of the prior art.

### DESCRIPTION OF EMBODIMENTS

An embodiment of the battery and battery production method of the present disclosure will be described below, but the battery and battery production method of the present disclosure is not limited to the following embodiment.

### 1. Problems of Battery of Prior Art

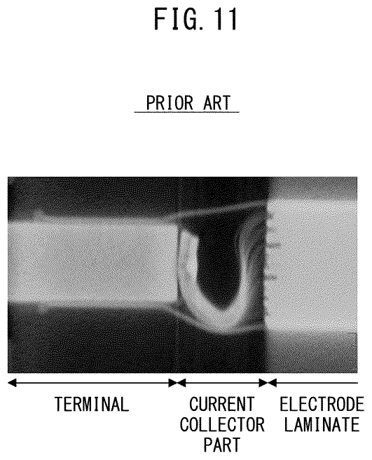

FIG. 11 shows an example of the cross-sectional configuration of a battery of the prior art. As shown in FIG. 11, in the battery of the prior art, the current collector part protruding from the electrode laminate is bent so as to connect the current collector part to the terminal while ensuring structural efficiency around the terminal and the current collector part. In this case, as shown in FIG. 11, there are concerns regarding deterioration of the current collector part due to the curvature R of the current collector part becoming excessively small, and deterioration of the exterior body due to the current collector part coming into contact with the exterior body. Furthermore, in the battery of the prior art, the contact area between the terminal and the current collector part is small, and there is room for improvement regarding connectivity between the terminal and the current collector part.

### 2. Battery of Present Disclosure

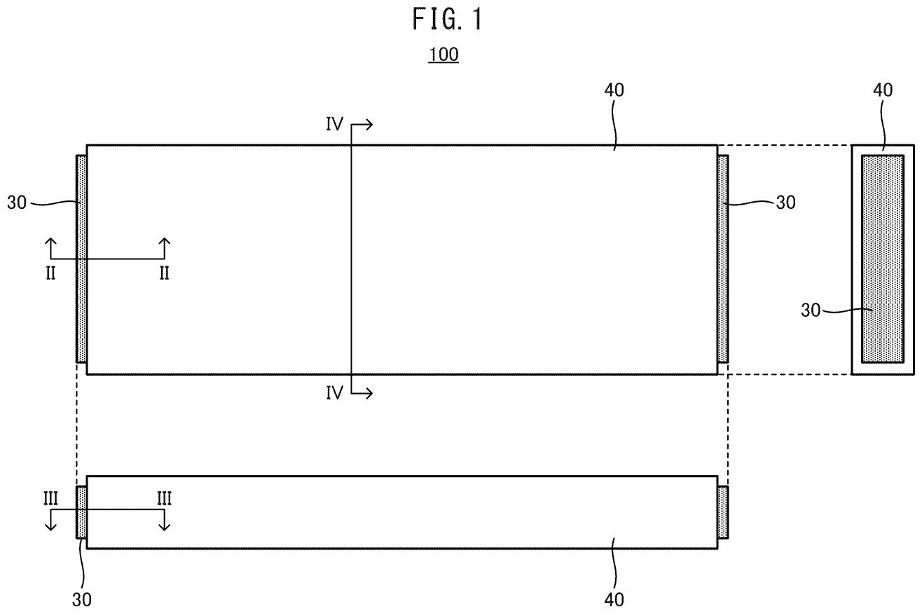

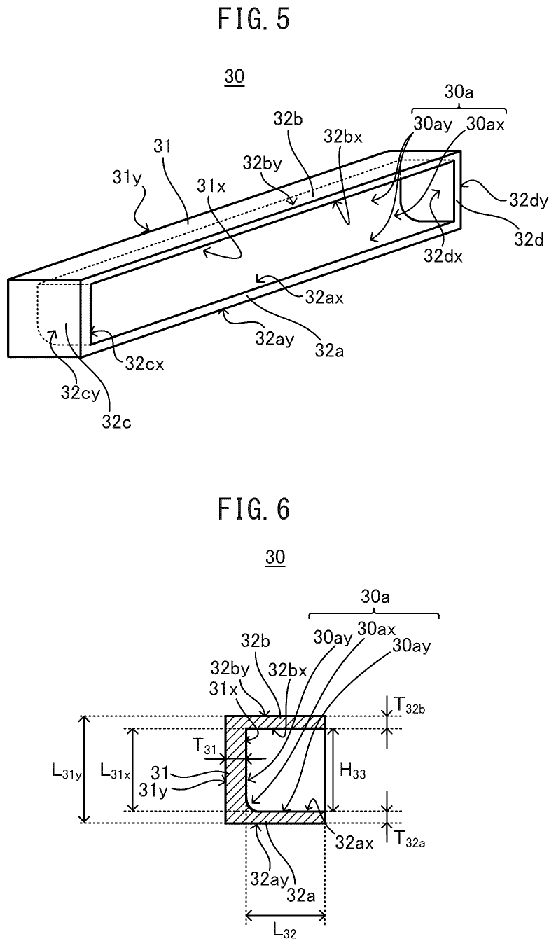

In light of the problems described above, the present application discloses a battery which can improve connectivity between a terminal and a current collector part while improving structural efficiency around the terminal and the current collector part. As shown in FIGS. 1 to 7, a battery 100 according to an embodiment comprises an electrode laminate 10, a current collector part 20, and a terminal 30. The current collector part 20 protrudes from the electrode laminate 10. As shown in FIGS. 5 and 6, the terminal 30 has a contact surface 30a with the current collector part 20. The contact surface 30a has a curved surface 30ax. The curved surface 30ax bulges toward the side opposite the current collector part 20.

### 2.1 Electrode Laminate

The battery 100 supplies the power generated by the electrode laminate 10 to external devices and the like via the current collector part 20 and the terminal 30. Specifically, the electrode laminate 10 functions as a power generating element of the battery 100.

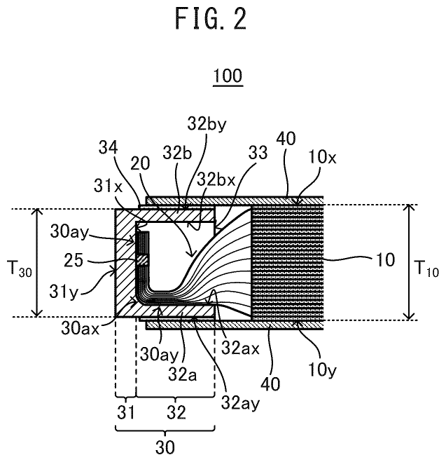

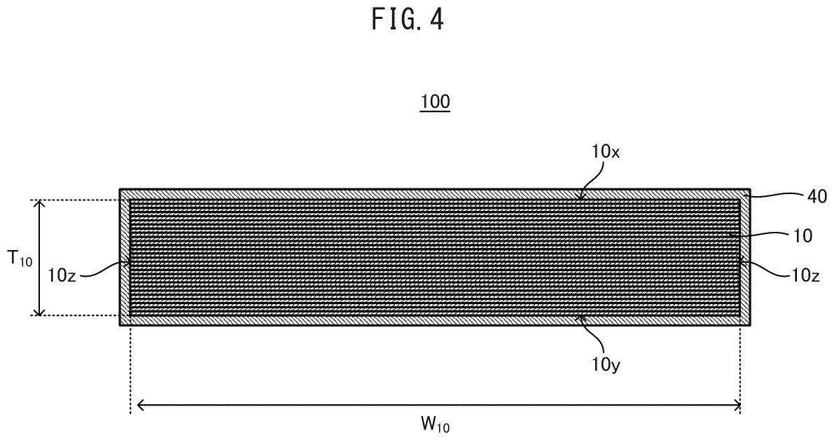

As shown in FIGS. 2 and 4, the electrode laminate 10 may be formed by stacking a plurality of electrode bodies. Each electrode body can comprise, for example, a layer composed of a positive electrode current collector, a positive electrode active material layer, an electrolyte layer, a negative electrode active material layer, and a layer composed of a negative electrode current collector. The positive electrode current collector, the positive electrode active material layer, the electrolyte layer, the negative electrode active material layer, and the negative electrode current collector may be publicly known components. The electrode laminate 10 may contain a solid electrolyte, a liquid electrolyte, or a solid electrolyte and a liquid electrolyte. When the electrode laminate 10 contains at least a solid electrolyte, a battery 100 having excellent mechanical properties, output properties, etc., can easily be obtained. The shape of the lamination surface of the layers constituting the electrode laminate 10 may be, for example, rectangular.

The number of electrode bodies stacked in the electrode laminate 10 is not particularly limited. In the electrode laminate 10, the plurality of electrode bodies may be connected to each other in series or in parallel. The electrode laminate 10 may have a bipolar structure. In the electrode laminate 10, the lamination surfaces of the electrode bodies may be insulated from each other by providing an insulating layer between one electrode body and another electrode body. As shown in FIG. 2, in the battery 100, the plurality of electrode bodies can be electrically connected to each other by the current collector part 20. For example, the plurality of electrode bodies can be electrically connected to each other in parallel by the current collector part 20.

As shown in FIGS. 2 to 4, the electrode laminate 10 may have an end surface 10x at one end in the lamination direction of each of the layers, an end surface 10y at the other end in the lamination direction of each of the layers, and side surfaces 10z each connecting the end surface 10x and the end surface 10y. Each side surface 10z may be formed by the outer edges of the layers constituting the electrode laminate 10. In the electrode laminate 10, the lamination areas of the layers may differ so that the side surfaces 10z may have concavities and convexities or gaps. Each side surface 10z may have a surface along the lamination direction of the layers in the electrode laminate 10. The current collector part 20, which is described later, can protrude from the side surface 10z of the electrode laminate 10 to the terminal 30. The electrode laminate 10 may be, for example, in the shape of a plate or a rectangular parallelepiped as a whole.

As shown in FIGS. 2 and 4, the electrode laminate 10 can have a thickness T₁₀ along the lamination direction. The thickness T₁₀ of the electrode laminate 10 is not particularly limited. The thickness T₁₀ of the electrode laminate 10 may be, for example, 5 mm or more and 100 mm or less, or 10 mm or more and 50 mm or less.

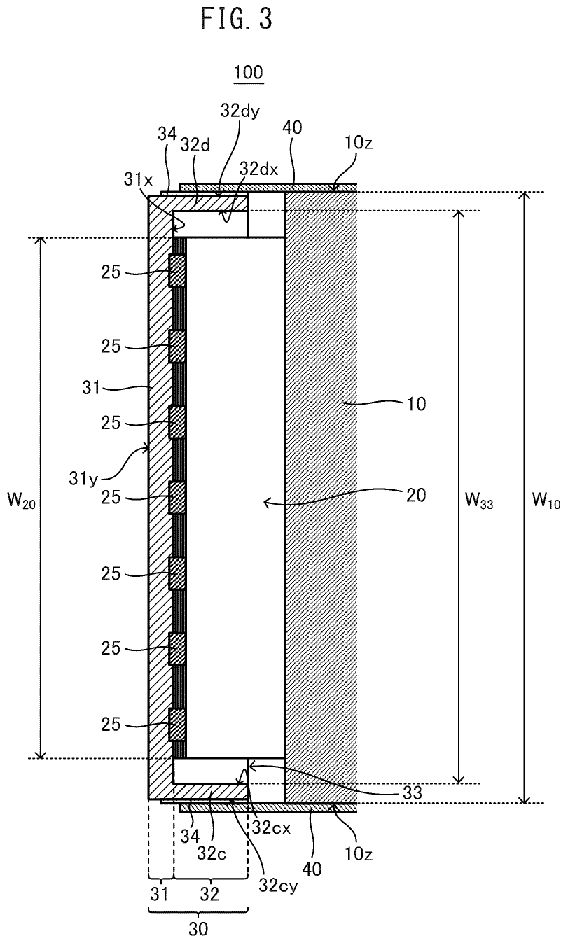

As shown in FIGS. 3 and 4, the electrode laminate 10 can have a width W₁₀ along the lamination surface at the side surface 10z where the current collector part 20 protrudes. The width W₁₀ of the electrode laminate 10 is not particularly limited. The width W₁₀ of the electrode laminate 10 may be, for example, 10 mm or more and 500 mm or less, or 50 mm or more and 200 mm or less.

### 2.2 Current Collector Part

The current collector part 20 protrudes from the electrode laminate 10, is connected to the contact surface 30a of the terminal 30, and electrically connects the electrode laminate 10 and the terminal 30.

As shown in FIGS. 2 and 3, the current collector part 20 may be, for example, a bundle of a plurality of current collectors protruding from the side surface 10z of the electrode laminate 10 toward the terminal 30. The number of current collectors protruding in the same direction from the electrode laminate 10 is not particularly limited, and may be, for example, 2 to 500, or 30 to 100. In the battery 100, the current collector part 20 may be a bundle of a plurality of positive electrode current collectors, or a bundle of a plurality of negative electrode current collectors. In the battery 100, the plurality of current collectors protruding from the side surface 10z of the electrode laminate 10 toward the terminal 30 may be grouped to form one bundle, or may be grouped to form a plurality of bundles.

The current collector constituting the current collector part 20 may be, for example, a metal foil or a metal mesh. From the viewpoint of excellent handling, the current collector part 20 may comprise a plurality of metal foils. Examples of the metal constituting the current collector include Cu, Ni, Cr, Au, Pt, Ag, Al, Fe, Ti, Zn, Co, and stainless steel. The current collector may have some type of coating layer on the surface thereof for the purpose of adjusting the resistance, etc. Furthermore, when the current collector part 20 is composed of a plurality of metal foils, some type of layer may be present between the plurality of metal foils. The thickness of each current collector is not particularly limited. For example, it may be 0.1 μm or more, it may be 1 μm or more, it may be 1 mm or less, and it may be 100 μm or less.

As shown in FIG. 3, the current collector part 20 can have a width W₂₀ in a direction perpendicular to the protrusion direction of the current collector part 20 from the electrode laminate 10 and along the lamination surface of the electrode laminate 10. The width W₂₀ of the current collector part 20 is not particularly limited. The width W₂₀ of the current collector part may be, for example, 5 mm or more and 450 mm or less, or 20 mm or more and 190 mm or less.

### 2.3 Terminal

As shown in FIGS. 2, 3, and 5 to 7, the terminal 30 has a contact surface 30a with the current collector part 20. The contact surface 30a has a curved surface 30ax. The curved surface 30ax bulges toward the side opposite the current collector part 20. “The curved surface bulges toward the side opposite the current collector part” means that the curved surface 30ax is a concave surface. By including the curved surface 30ax in the contact surface 30a of the terminal 30 with the current collector part 20, the current collector part 20 can be connected to the terminal 30 while being aligned with the contact surface 30a. Specifically, the contact area between the contact surface 30a and the current collector part 20 is increased, whereby connectivity of the current collector part 20 with the terminal 30 is improved. Furthermore, since the contact surface 30a is a concave surface, a part of the current collector part 20 can be housed in the space formed by the concave surface, whereby structural efficiency around the terminal 30 can be improved.

### 2.3.1 Contact Surface

As described above, the contact surface 30a of the terminal 30 has a curved surface 30ax which bulges toward the side opposite the current collector part 20. In the battery 100, the current collector part 20 contacts the contact surface 30a along the contact surface 30a including the curved surface 30ax, whereby the connection between the current collector part 20 and the terminal 30 is secured. The radius of curvature of the curved surface 30ax can be appropriately determined in accordance with the bundle shape of the current collector part 20, the size of the terminal 30, etc. For example, the contact surface 30a may have a curved surface 30ax having a radius of curvature of 0.5 mm or more and 50 mm or less. The contact surface 30a may have the curved surface 30ax in only a part thereof, or the entire contact surface 30a may be constituted by the curved surface 30ax. The contact surface 30a may be a combination of a flat surface 30ay and a curved surface 30ax as shown in the drawings, or may be a combination of a plurality of curved surfaces 30ax having different radii of curvature.

2.3.2 Surfaces Other than Contact Surface

The terminal 30 can have a surface other than the contact surface 30a. The surface other than the contact surface 30a is not particularly limited. For example, as shown in FIGS. 2, 3, and 5 to 7, when the electrode laminate 10 and the current collector part 20 are housed in the exterior body 40, the terminal 30 may have the contact surface 30a inside the exterior body 40, and the terminal 30 may have an exposed surface (for example, a second surface 31y, which will be described later) which faces the exterior of the exterior body 40. Furthermore, as shown in FIGS. 2 and 3, the terminal 30 may have an adhesive surface with the exterior body 40 (for example, a fourth surface 32ay or a sixth surface 32by, which will be described later).

### 2.3.3 Specific Examples of Shape of Terminal

Specific examples of the shape of terminal 30 will be described below, but the shape of terminal 30 is not limited to the specific shapes described below. As shown in FIGS. 2, 3, and 5 to 7, the terminal 30 may comprise a base 31 and a protrusion 32. The base 31 may have a first surface 31x and a second surface 31y opposite the first surface 31x. The protrusion 32 may protrude from the base 31 toward the electrode laminate 10. The protrusion 32 may comprise a first protrusion 32a and a second protrusion 32b. The first protrusion 32a may have a third surface 32ax facing the second protrusion 32b and a fourth surface 32ay opposite the third surface 32ax. The second protrusion 32b may have a fifth surface 32bx facing the first protrusion 32a and a sixth surface 32by opposite the fifth surface 32bx. In this case, at least one of the first surface 31x, the third surface 32ax, and the fifth surface 32bx may have the contact surface 30a described above. When the terminal 30 has such a shape, structural efficiency around the terminal 30 can easily be further improved.

As shown in FIGS. 2 and 3, when the electrode laminate 10 and the current collector part 20 are housed in the exterior body 40, the first surface 31x, the third surface 32ax, and the fifth surface 32bx may face the interior of the exterior body 40, the second surface 31y may face the exterior of the exterior body 40, and the fourth surface 32ay and the sixth surface 32by may be adhered to the exterior body 40. When the electrode laminate 10, the current collector part 20, the terminal 30, and the exterior body 40 satisfy such a positional relationship, structural efficiency around the terminal 30 can easily be further improved.

### 2.3.3.1 Base

As shown in FIGS. 2, 3, and 5 to 7, the base 31 can have a first surface 31x facing the electrode laminate 10 and a second surface 31y facing the side opposite the electrode laminate 10. The base 31 may correspond to, for example, the bottom of a vessel-shaped terminal 30. As shown in FIGS. 2 and 3, the first surface 31x may be in contact with the current collector part 20, and may have a joint 25 with the current collector part 20. The second surface 31y may face the outside of the battery 100. The first surface 31x and the second surface 31y of the base 31 may be, for example, flat surfaces as shown in the drawings, or may have concavities and convexities. Furthermore, the first surface 31x may constitute the contact surface 30a having the curved surface 30ax as described above. The planar shapes of the first surface 31x and the second surface 31y (referring to the planar shape when the first surface and the second surface are projected) is not particularly limited. Though the planar shapes of the illustrated first surface 31x and second surface 31y are elongated rectangles, the planar shapes may be square, quadrangles other than rectangles (elongated rectangles and squares), other polygonal shapes, circles, ellipses, or other shapes. In particular, when the first surface 31x and second surface 31y are rectangular, and especially when they are elongated rectangles, case of handling and mechanical strength are likely to be improved. Note that the terms “polygon”, “quadrangle”, “rectangle”, and “elongated rectangle” in the present description each include concepts including shapes with chamfered corners and shapes with rounded corners.

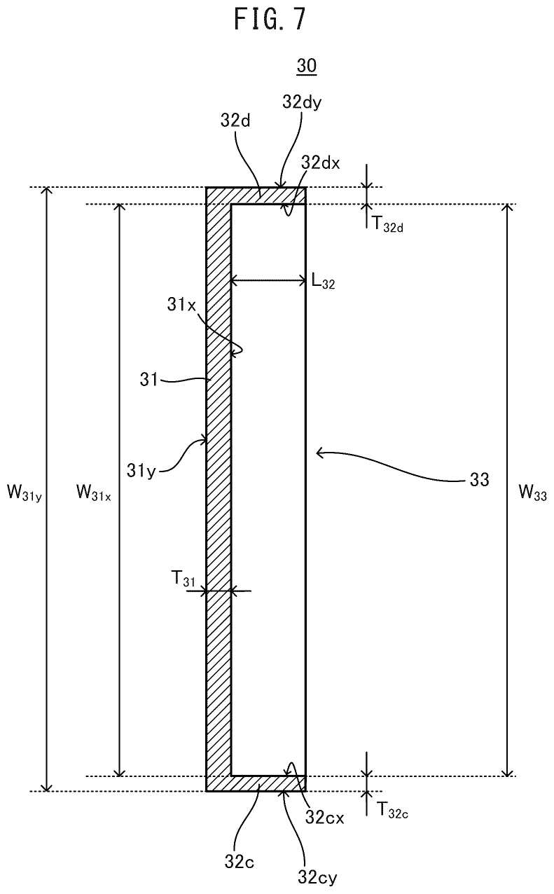

As shown in FIGS. 6 and 7, the base 31 can have a thickness T₃₁ (minimum thickness from the first surface 31x to the second surface 31y). The thickness T₃₁ of the base 31 is not particularly limited. In particular, when the thickness T₃₁ of the base 31 is 0.1 mm or more and 10 mm or less or 0.2 mm or more and 3 mm or less, the structural efficiency around the terminal 30 and the strength of the terminal 30 tend to be well balanced.

As shown in FIG. 6, the base 31 can have a length (height) L₃₁ₓ along the lamination direction in the electrode laminate 10 in the inner dimension of the first surface 31x (from the inner surface of the first protrusion 32a to the inner surface of the second protrusion 32b). As shown in FIG. 6, the length L₃₁ₓ in the inner dimension of the first surface 31x of the base 31 may be the same as the height H₃₃ of the opening 33 of the terminal 30, which will be described later. Alternatively, the length L₃₁ₓ in the inner dimension of the first surface 31x of the base 31 may be smaller or larger than the height H₃₃. The length L₃₁ₓ in the inner dimension of the first surface 31x of the base 31 is not particularly limited, and may be 4.8 mm or more and 99.8 mm or less or 9.8 mm or more and 49.8 mm or less.

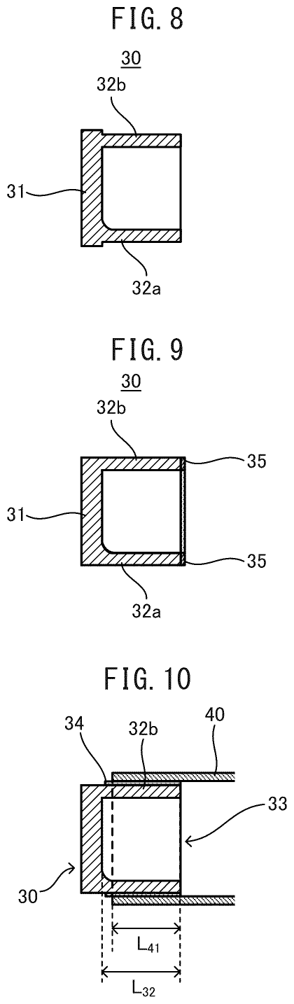

As shown in FIG. 6, the base 31 can have a length (height) L_{31y} at the second surface 31y along the lamination direction in the electrode laminate 10. As shown in FIGS. 2 and 6, the length L_{31y} at the second surface 31y of the base 31 may be the same as the thickness T₃₀ of the terminal 30 (the length from the fourth surface 32ay of the first protrusion 32a to the sixth surface 32by of the second protrusion 32b). Alternatively, the length L_{31y} at the second surface 31y of the base 31 may be greater than the thickness T₃₀ of the terminal 30. Specifically, as shown in FIG. 8, the first protrusion 32a and the second protrusion 32b may protrude from inside the outer edge of the first surface 31x of the base 31 toward the electrode laminate 10. The length L_{31y} of the second surface 31y of the base 31 is not particularly limited, and may be 4.9 mm or more and 99.9 mm or less or 9.9 mm or more and 49.9 mm or less.

As shown in FIG. 7, the base 31 can have a width W₃₁ₓ along the lamination surface of the electrode laminate 10 in the inner dimension of the first surface 31x. As shown in FIG. 7, the width W₃₁ₓ in the inner dimension of the first surface 31x of the base 31 may be the same as the width W₃₃ of the opening 33 of the terminal 30, which will be described later. Alternatively, the width W₃₁ₓ in the inner dimension of the first surface 31x of the base 31 may be smaller than the width W₃₃. The width W₃₁ₓ in the inner dimension of the first surface 31x of the base 31 is not particularly limited, and may be 7.5 mm or more and 475 mm or less or 30 mm or more and 195 mm or less.

As shown in FIG. 7, the base 31 can have a width W_{31y} at the second surface 31y along the lamination surface of the electrode laminate 10. As shown in FIG. 7, the width W_{31y} of the second surface 31y of the base 31 may be the same as the sum of the width W₃₃ of the opening 33, the thickness T_{32c} of the third protrusion 32c, and the thickness T_{32d} of the fourth protrusion 32d, of the terminal 30, which will be described later. Alternatively, the width W_{31y} of the second surface 31y of the base 31 may be larger than the sum of the width W₃₃, the thickness T_{32c}, and the thickness T_{32d}. The width W_{31y} of the second surface 31y of the base 31 is not particularly limited, and may be 8.1 mm or more and 475.1 mm or less or 30.1 mm or more and 195.1 mm or less.

The ratio L₃₁ₓ/W₃₁ₓ of the length (height) L₃₁ₓ to the width W₃₁ₓ of the first surface 31x of the base 31 is not particularly limited. In particular, when the ratio L₃₁ₓ/W₃₁ₓ is 0.01 or more and 13.3 or less or 0.05 or more and 1.66 or less, the connectivity of the current collector part 20 to the terminal 30 and the strength of the terminal are easily secured.

The ratio L_{31y}/W_{31y} of the length (height) L_{31y} to the width W_{31y} of the second surface 31y of the base 31 is not particularly limited. In particular, when the ratio L_{31y}/W_{31y} is 0.01 or more and 13.3 or less or 0.05 or more and 1.66 or less, the connectivity of the current collector part 20 to the terminal 30 and the strength of the terminal are easily secured.

### 2.3.3.2 Protrusion

The protrusion 32 protrudes from the base 31 toward the electrode laminate 10. As shown in FIGS. 2, 3, and 5 to 7, the protrusion 32, excluding the portion on which the curved surface 30ax described above is formed, may protrude linearly from the base 31 toward the electrode laminate 10 while having a thickness. As shown in FIG. 2, the protrusion 32 can comprise a first protrusion 32a and a second protrusion 32b in one cross section. The first protrusion 32a has a third surface 32ax facing the second protrusion 32b and a fourth surface 32ay opposite the third surface 32ax. The second protrusion 32b has a fifth surface 32bx facing the first protrusion 32a and a sixth surface 32by opposite the fifth surface 32bx. Furthermore, as shown in FIG. 3, the protrusion 32 may have a third protrusion 32c and a fourth protrusion 32d in a cross section perpendicular to the one cross section. In this case, the third protrusion 32c may have a seventh surface 32cx facing the fourth protrusion 32d and an eighth surface 32cy opposite the seventh surface 32cx. The fourth protrusion 32d may have a ninth surface 32dx facing the third protrusion 32c and a tenth surface 32dy opposite the ninth surface 32dx.

In the battery 100, the thickness T₃₂ of the protrusion 32 (for example, T₃₂ₐ to T_{32d} in FIGS. 6 and 7) is not particularly limited. In particular, when the thickness T₃₂ of the protrusion 32 is 0.1 mm or more and 10 mm or less or 0.2 mm or more and 3 mm or less, connectivity of the current collector part 20 to the terminal 30 and the strength of the terminal are easily secured. Note that the “thickness of the protrusion” in the present description is measured at the end surface of the protrusion on the electrode laminate side.

As shown in FIGS. 6 and 7, the protrusion 32 can have a protrusion length L₃₂ from the first surface 31x of the base 31 toward the electrode laminate 10. The protrusion length L₃₂ of the protrusion 32 is not particularly limited and may be 3 mm or more and 50 mm or less or 5 mm or more and 30 mm or less. The protrusion 32 may have the same protrusion length L₃₂ as a whole. Specifically, the first protrusion 32a, the second protrusion 32b, the third protrusion 32c, and the fourth protrusion 32d may be flush with each other at the end surfaces on the electrode laminate 10 side. Alternatively, the protrusion length of a part of the protrusion 32 may be different from the protrusion length of the other parts of the protrusion 32.

As shown in FIGS. 6 and 7, the thickness T₃₁ of the base 31 may be smaller than the protrusion length L₃₂ of the protrusion 32. By making the thickness T₃₁ of the base 31 relatively thin, the space for inserting the current collector part 20 is increased. The ratio T₃₁/L₃₂ of the thickness T₃₁ of the base 31 to the protrusion length L₃₂ of the protrusion 32 may be, for example, more than 0 and less than 1.0, 0.02 or more and 0.5 or less, or 0.05 or more and 0.25 or less.

As shown in FIGS. 2, 3, and 5 to 7, in the terminal 30, the protrusion 32 may protrude from the outer edge of the base 31. Specifically, the planar shape of the second surface 31y of the base 31 may coincide with the shape defined by the outer periphery of the protrusion 32. Alternatively, as shown in FIG. 9, the protrusion 32 may protrude from inside the outer edge of the first surface 31x of the base 31. Specifically, the planar shape of the second surface 31y of the base 31 may be larger than the shape defined by the outer periphery of the protrusion 32.

When the protrusion 32 protrudes from the outer edge of the base 31, the shape defined by the outer periphery of the protrusion 32 corresponds to the planar shape of the second surface 31y of the base 31. For example, when the planar shape of the base 31 (planar shape of the second surface 31y) is rectangular, the rectangle has a first side and a second side facing each other and a third side and a fourth side facing each other, and the protrusion 32 comprises the first protrusion 32a, the second protrusion 32b, the third protrusion 32c, and the fourth protrusion 32d, the first protrusion 32a may protrude from the first side, the second protrusion 32b may protrude from the second side, the third protrusion 32c may protrude from the third side, and the fourth protrusion 32d may protrude from the fourth side. By adopting a configuration in which the protrusion 32 protrudes from the outer edge of the rectangular base 31 in this manner, the structural efficiency around the terminal and the strength of the terminal can easily be secured.

For example, when the planar shape of the base 31 (planar shape of the second surface 31y) is an elongated rectangle, the first protrusion 32a may protrude from one long side of the elongated rectangle, the second protrusion 32b may protrude from the other long side of the elongated rectangle, the third protrusion 32c may protrude from one short side of the elongated rectangle, and the fourth protrusion 32d may protrude from the other short side of the elongated rectangle. Since the protrusion 32 protrudes from the outer edge of the elongated rectangular base 31 in this manner, the structural efficiency around the terminal and the strength of the terminal can easily be secured. Furthermore, by forming the contact surface 30a with the current collector part 20 on the long side, the connectivity between the current collector part 20 and the terminal 30 can easily be further improved.

Furthermore, when the planar shape of the base 31 (planar shape of the second surface 31y) is an elongated rectangle, the lamination direction in the electrode laminate 10 may be along the short sides of the elongated rectangle, and the width direction of the electrode laminate 10 may be along the long sides of the elongated rectangle. As a result, a large space for inserting the current collector part 20 can easily be secured, connectivity between the terminal 30 and the current collector part 20 can be improved, and an excellent balance of structural efficiency and strength around the terminal 30 and the current collector part 20 can easily be achieved.

The first protrusion 32a may have a third surface 32ax facing the second protrusion 32b and a fourth surface 32ay opposite the third surface 32ax. As shown in FIG. 2, the third surface 32ax may contact the current collector part 20. The third surface 32ax may have a joint with the current collector part 20. Conversely, as shown in FIG. 2, the fourth surface 32ay may be an adhesive surface with the exterior body 40. The third surface 32ax and the fourth surface 32ay of the first protrusion 32a may have flat surfaces as shown in the drawing, or may have concavities and convexities. Furthermore, as described above, the third surface 32ax may constitute the contact surface 30a having the curved surface 30ax. The planar shapes of the third surface 32ax and the fourth surface 32ay (referring to the planar shapes when the third surface and the fourth surface are projected) are not particularly limited. In particular, when the third surface 32ax and the fourth surface 32ay have rectangular planar shapes, the structural efficiency around the terminal 30 is likely to be improved, and the connectivity of the current collector part 20 to the terminal 30 and the strength of the terminal 30 are likely to be improved.

The second protrusion 32b may have a fifth surface 32bx facing the first protrusion 32a and a sixth surface 32by opposite the fifth surface 32bx. The fifth surface 32bx may or may not have the contact surface 30a with the current collector part 20. Conversely, as shown in FIG. 2, the sixth surface 32by may be an adhesive surface with the exterior body 40. The fifth surface 32bx and the sixth surface 32by of the second protrusion 32b may be, for example, flat surfaces as shown in the drawing, or may have concavities and convexities. Furthermore, as described above, the fifth surface 32bx may constitute the contact surface 30a having the curved surface 30ax. The planar shapes of the fifth surface 32bx and the sixth surface 32by (referring to the planar shapes when the fifth surface and the sixth surface are projected) are not particularly limited. In particular, when the fifth surface 32bx and the sixth surface 32by have rectangular planar shapes, the structural efficiency around the terminal 30 is likely to be improved, and the connectivity of the current collector part 20 to the terminal 30 and the strength of the terminal 30 are likely to be improved.

The third protrusion 32c may have a seventh surface 32cx facing the fourth protrusion 32d and an eighth surface 32cy opposite the seventh surface 32cx. As shown in FIG. 3, the seventh surface 32cx need not contact the current collector part 20. Conversely, as shown in FIG. 3, the eighth surface 32cy may be an adhesive surface with the exterior body 40. The seventh surface 32cx and the eighth surface 32cy of the third protrusion 32c may be, for example, flat surfaces as shown in the drawing, or may have concavities and convexities. The planar shapes of the seventh surface 32cx and the eighth surface 32cy (referring to the planar shapes when the seventh surface and the eighth surface are projected) are not particularly limited. In particular, when the seventh surface 32cx and the eighth surface 32cy have rectangular planar shapes, the structural efficiency around the terminal 30 is likely to be improved, and the connectivity of the current collector part 20 to the terminal 30 and the strength of the terminal 30 are likely to be improved.

The fourth protrusion 32d may have a ninth surface 32dx facing the third protrusion 32c and a tenth surface 32dy opposite the ninth surface 32dx. As shown in FIG. 3, the ninth surface 32dx need not contact the current collector part 20. Conversely, as shown in FIG. 3, the tenth surface 32dy may be an adhesive surface with the exterior body 40. The ninth surface 32dx and the tenth surface 32dy of the fourth protrusion 32d may be, for example, a flat surface as shown in the drawing, or may have concavities and convexities. The planar shapes of the ninth surface 32dx and the tenth surface 32dy (referring to the planar shapes when the seventh surface and the eighth surface are projected) are not particularly limited. In particular, when the ninth surface 32dx and the tenth surface 32dy have rectangular planar shapes, the structural efficiency around the terminal 30 is likely to be improved, and the connectivity of the current collector part 20 to the terminal 30 and the strength of the terminal 30 are likely to be improved.

### 2.3.3.3 Opening

As shown in FIGS. 2, 3, and 5 to 7, the terminal 30 may have an opening 33 on the electrode laminate 10 side. In this case, the current collector part 20 can be inserted into the opening 33 and connected to the terminal 30. The shape of the opening 33 can be defined in accordance with the protrusion 32. The shape of the opening 33 is not particularly limited. The shape of the opening 33 may be rectangular, circular, or elliptical, or may be another shape.

When the shape of the opening 33 is rectangular and the rectangle has a first side and a second side facing each other and a third side and a fourth side facing each other, the first protrusion 32a of the protrusion 32 may constitute the first side, the second protrusion 32b may constitute the second side, the third protrusion 32c may constitute the third side, and the fourth protrusion 32d may constitute the fourth side. When the shape of the opening 33 defined by the protrusion 32 is rectangular, it becomes easier to ensure the structural efficiency around the terminal and the strength of the terminal.

When the shape of the opening 33 is an elongated rectangle, the first protrusion 32a of the protrusion 32 may constitute one short side of the elongated rectangle, the second protrusion 32b may constitute the other short side of the elongated rectangle, the third protrusion 32c may constitute one long side of the elongated rectangle, and the fourth protrusion 32d may constitute the other long side of the elongated rectangle. In this case as well, the structural efficiency around the terminal and the strength of the terminal can easily be secured.

When the shape of the opening 33 is an elongated rectangle, the lamination direction in the electrode laminate 10 may be along the short sides of the elongated rectangle, and the width direction of the electrode laminate 10 may be along the long sides of the elongated rectangle. As a result, a large space for inserting the current collector part 20 can easily be secured, and an excellent balance of structural efficiency and strength around the terminal 30 and the current collector part 20 can easily be achieved.

As shown in FIG. 6, the opening 33 can have a height H₃₃ along the lamination direction in the electrode laminate 10. The height H₃₃ of the opening 33 is not particularly limited. In particular, when the height H₃₃ of the opening 33 is 4.8 mm or more and 99.8 mm or less, or 9.8 mm or more and 49.8 mm or less, the strength of the terminal 30 is easily secured, and the current collector part 20 can more easily be inserted into the opening 33 and joined to the terminal 30.

As shown in FIG. 7, the opening 33 can have a width W₃₃ along the lamination surface of the electrode laminate 10. The width W₃₃ of the opening 33 is not particularly limited. In particular, when the width W₃₃ of the opening 33 is 7.5 mm or more and 475 mm or less, or 30 mm or more and 195 mm or less, the strength of the terminal 30 is easily secured, and the width W₂₀ of the current collector part 20 is easily secured sufficiently.

The ratio H₃₃/W₃₃ of the height H₃₃ to the width W₃₃ of the opening 33 is not particularly limited. In particular, when the ratio H₃₃/W₃₃ is 0.01 or more and 13.3 or less, or 0.05 or more and 1.66 or less, the joinability of the current collector part 20 and the strength of the terminal 30 are likely to be excellent.

### 2.3.4 Other Features Regarding Terminal

As described above, the base 31 can have a thickness T₃₁, and the protrusion 32 can have a thickness T₃₂. The relationship between the thickness T₃₁ of the base 31 and the thicknesses T₃₂ₐ and T_{32b} of the first protrusion 32a and second protrusion 32b is not particularly limited. In particular, when the base 31 is thicker than the first protrusion 32a and second protrusion 32b, the structural efficiency around the terminal and the strength of the terminal are likely to be improved.

The relationship of the thickness T₃₁ of the base 31 with the thicknesses T_{32c} and T_{32d} of the third protrusion 32c and fourth protrusion 32d is not particularly limited. In particular, when the base 31 is thicker than the third protrusion 32c and fourth protrusion 32d, the structural efficiency around the terminal and the strength of the terminal are likely to be improved.

The terminal 30 can be easily produced by, for example, pressing a metal material with a punch or the like to form a desired concave shape, cutting a metal material to form a desired concave shape, or subjecting a metal material to electric discharge machining to form a desired concave shape. The material of the terminal 30 may be appropriately selected taking into consideration sufficient electrical conductivity, appropriate mechanical strength, etc. For example, the material of the terminal 30 may be aluminum, copper, iron, nickel, or an alloy thereof. The terminal 30 may be a base material plated with any of the above metals or alloys thereof.

An insulating layer may be provided between the terminal 30 and the electrode laminate 10. As a result, short circuits in the battery 100 can more easily be suppressed. For example, as shown in FIG. 10, the protrusion 32 of the terminal 30 may have an insulating layer 35 on the end surface on the electrode laminate 10 side. For example, the insulating layer 35 can be formed on the end surface by applying or transferring an insulating resin material (for example, an ultraviolet-curing resin such as acrylic monomer/oligomer; thermosetting resin such as epoxy resin or imide resin; or thermoplastic resin such as polypropylene or polyethylene) to the end surface of the protrusion 32 of the terminal 30, or by forming a layer composed of a metal oxide (for example, aluminum oxide) on the end surface by anodization or the like. The thickness of the insulating layer 35 is not particularly limited. When the insulating layer 35 is composed of an insulating resin material, the thickness may be, for example, 0.1 mm or more and 1.0 mm or less. Furthermore, when the insulating layer 35 is composed of a metal oxide formed by anodization or the like, the thickness thereof may be, for example, 0.01 mm or more and less than 0.10 mm.

### 2.4 Supplementary Information Regarding Arrangement of Electrode Laminate, Current Collector Part, and Terminal

In the battery 100, the arrangement of the electrode laminate 10, the current collector part 20, and the terminal 30 is not particularly limited as long as the current collector part 20 protruding from the electrode laminate 10 is electrically connected to a predetermined surface of the terminal 30. Since a terminal 30 having the specific shape described above is adopted in the battery 100, space around the terminal 30 and the current collector part 20 can easily be saved, and the connectivity of the current collector part 20 to the terminal 30 can easily be improved. An example of the arrangement of the electrode laminate 10, the current collector part 20, and the terminal 30 will be supplemented below.

### 2.4.1 Width of Terminal and Width of Current Collector Part

As described above, the current collector part 20 protruding from the electrode laminate 10 may be inserted into the opening 33 of the terminal 30 and connected to a predetermined surface of the terminal 30. When a large current flows through the current collector part 20 and the terminal 30, heat can be generated in the current collector part 20 and the terminal 30. According to the knowledge of the present inventors, the heat generation temperature around the terminal 30 and the current collector part 20 varies depending on the width of the current collector part 20 relative to the width of the terminal 30. As shown in FIG. 3, for example, when the ratio W₂₀/W₃₃ of the width W₂₀ of the current collector part 20 to the width W₃₃ of the opening 33 of the terminal 30 is 0.9 or more, the heat generation around the terminal 30 and the current collector part 20 can be suppressed particularly remarkably. Alternatively, when the ratio W₂₀/W₃₁ₓ of the width W₂₀ of the current collector part 20 to the inner width W₃₁ₓ of the base 31 of the terminal 30 (the width at the inner dimension of the first surface 31x) is 0.9 or more, heat generation around the terminal 30 and the current collector part 20 can be suppressed particularly remarkably.

### 2.4.2 Thickness of Electrode Laminate and Thickness of Terminal

The thickness T₃₀ of the terminal 30 may be thicker than, equal to, or thinner than the thickness T₁₀ of the electrode laminate 10. In particular, as shown in FIG. 2, when the thickness T₃₀ of the terminal 30 is thinner than the thickness of the electrode laminate 10, it becomes easier to further improve the adhesion between the exterior body and the terminal 30 by, for example, arranging a resin 34 between the laminate exterior body and the terminal 30.

### 2.4.3 Joint Form Between Current Collector Part and Terminal

As described above, the current collector part 20 contacts with the contact surface 30a of the terminal 30. The current collector part 20 may be joined to a part of the contact surface 30a of the terminal 30 to form a joint 25. In an embodiment, the current collector part 20 may be ultrasonically joined or laser joined to at least a part of the contact surface 30a of the terminal 30.

### 2.5 Other Members

The battery 100 can have obvious structures as a battery in addition to the above-mentioned electrode laminate 10, current collector part 20, and terminal 30. For example, various members such as those disclosed in Patent Literature 1 (Japanese Unexamined Patent Publication (Kokai) No. 2023-084066) can be adopted as other members. Examples of other members provided in the battery 100 will be described below.

### 2.5.1 Exterior Body

The battery 100 can comprise an exterior body 40 for housing the electrode laminate 10 and the current collector part 20. The exterior body may be a laminate exterior body composed of a laminate film or may be composed of a metal case. As shown in the drawings, the electrode laminate 10 and the current collector part 20 may be housed in a laminate exterior body, and the laminate exterior body may be adhered to a fourth surface 32ay of the first protrusion 32a and a sixth surface 32by of the second protrusion 32b.

The exterior body 40 may be, for example, a cylindrical body having an opening. Specifically, as shown in FIGS. 2 and 3, the electrode laminate 10 and the current collector part 20 can be housed inside the cylindrical exterior body 40, and the outer surface of the protrusion 32 of the terminal 30 can be adhered and sealed to the vicinity of the opening of the exterior body 40. In this case, as shown in FIGS. 2 and 3, the vicinity of the opening of the exterior body 40 and the protrusion 32 of the terminal 30 can be adhered to each other so as to overlap each other when viewed in the lamination direction in the electrode laminate 10. This can improve the structural efficiency around the terminal 30 while increasing the sealing performance of the battery 100.

As shown in FIG. 10, the length L₄₁ between the electrode laminate 10 side end surface (or opening 33) of the terminal 30 and the opening 41 of the exterior body 40 is not particularly limited. In particular, when the length L₄₁ is 1.0 mm or more and 20 mm or less, or 3.0 mm or more and 15 mm or less, the balance between the sealing performance and the structural efficiency is likely to be suitable. Furthermore, the ratio L₄₁/L₃₂ of the length L₄₁ to the protrusion length L₃₂ of the protrusion 32 is not particularly limited. In particular, when the ratio L₄₁/L₃₂ is 0.1 or more and 1.0 or less, or 0.5 or more and 1.0 or less, the balance between the sealing performance and the structural efficiency is likely to be suitable. When the exterior body 40 is a laminate exterior body, the laminate exterior body may be adhered to the outer surface of the protrusion 32 by heat sealing or the like, for example. Furthermore, when the exterior body 40 is a metal case, the metal case can be adhered to the outer circumferential surface of the protrusion 32 by, for example, welding or using an adhesive. As described above, the resin 34 may be arranged between the outer surface of the protrusion 32 and the exterior body 40.

### 2.5.2 Busbar

The battery 100 may comprise a conductive member for connecting one battery to another. For example, in the battery 100, a busbar may be connected to the terminal 30. A plurality of batteries 100 may be combined to form a battery assembly.

### 3. Applications

There are many applications for the battery 100. For example, the battery 100 can be suitably used in at least one type of vehicle selected from a hybrid electric vehicle (HEV), a plug-in hybrid electric vehicle (PHEV), and a battery electric vehicle (BEV). Specifically, an aspect of the technology of the present disclosure relates to a vehicle having the battery 100 of the present disclosure described above.

### DESCRIPTION OF REFERENCE SIGNS

100 battery
10 electrode laminate
20 current collector part
25 joint
30 terminal
30a contact surface
30ax curved surface
30ay flat surface
31 base
31x first surface
31y second surface
32 protrusion
32a first protrusion
32ax third surface
32ay fourth surface
32b second protrusion
32bx fifth surface
32by sixth surface
32c third protrusion
32cx seventh surface
32cy eighth surface
32d fourth protrusion
32dx ninth surface
32dy tenth surface
33 opening
34 resin
35 insulating layer
40 exterior body
41 opening

1. A battery, comprising an electrode laminate, a current collector part, and a terminal, wherein
the current collector part protrudes from the electrode laminate,
the terminal comprises a contact surface with the current collector part,
the contact surface has a curved surface, and
the curved surface bulges toward a side opposite the current collector part.

2. The battery according to claim 1, wherein
the electrode laminate and the current collector part are housed in an exterior body,
the terminal has the contact surface on an interior of the exterior body, and
the terminal has an exposed surface facing an outside of the exterior body.

3. The battery according to claim 1, wherein
the terminal comprises a base and a protrusion,
the base has a first surface and a second surface opposite the first surface,
the protrusion protrudes from the base toward the electrode laminate,
the protrusion comprises a first protrusion and a second protrusion,
the first protrusion has a third surface facing the second protrusion and a fourth surface opposite the third surface,
the second protrusion has a fifth surface facing the first protrusion and a sixth surface opposite the fifth surface, and
at least one of the first surface, the third surface, and the fifth surface has the contact surface.

4. The battery according to claim 3, wherein
the electrode laminate and the current collector part are housed in an exterior body,
the first surface, the third surface, and the fifth surface face an interior of the exterior body,
the second surface faces an exterior of the exterior body, and
the fourth surface and the sixth surface are adhered to the exterior body.

5. The battery according to claim 3, wherein
a planar shape of the base is a rectangle,
the protrusion comprises a third protrusion and a fourth protrusion,
the rectangle comprises a first side and a second side facing each other and a third side and a fourth side facing each other,
the first protrusion protrudes from the first side,
the second protrusion protrudes from the second side,
the third protrusion protrudes from the third side, and
the fourth protrusion protrudes from the fourth side.

6. The battery according to claim 4, wherein
a planar shape of the base is a rectangle,
the protrusion comprises a third protrusion and a fourth protrusion,
the rectangle comprises a first side and a second side facing each other and a third side and a fourth side facing each other,
the first protrusion protrudes from the first side,
the second protrusion protrudes from the second side,
the third protrusion protrudes from the third side, and
the fourth protrusion protrudes from the fourth side.
